(19) United States
(12) Patent Application Publication
(10) Pub. No.: US 2025/0085695 A1
(43) Pub. Date: Mar. 13, 2025

(54) CYCLE TIME CALCULATION APPARATUS

(71) Applicant: OKUMA Corporation, Niwa-gun (JP)

(72) Inventors: Shimpei HORII, Niwa-gun (JP); Yuki MIZUTANI, Niwa-gun (JP); Ken HORIBE, Niwa-gun (JP); Masahiro MAEDA, Niwa-gun (JP)

(21) Appl. No.: 18/825,579

(22) Filed: Sep. 5, 2024

(30) Foreign Application Priority Data
Sep. 7, 2023 (JP) 2023-145428
Apr. 18, 2024 (JP) 2024-067798

(51) Int. Cl. G05B 19/4155

(52) U.S. Cl. CPC G05B 19/4155; G05B 2219/31412

(57) ABSTRACT

A cycle time calculation apparatus includes: a plurality of resource process units, each provided in correspondence to one of a plurality of work resources, wherein each of the plurality of resource process units virtually judges progress of a process in a corresponding work resource; a process control unit which dynamically determines timings to start operations of the plurality of work resources, and sends a command to start a process to the resource process unit in accordance with a result of the determination; a cumulative management unit which measures a time in which a resource state of at least one of the resource process units is in-operation; and a cycle time calculation unit which calculates a cycle time, which is a time required for actually executing machining in accordance with the sequence program, based on a result of the measurement by the cumulative management unit.

### CROSS REFERENCE TO RELATED APPLICATION

The present invention claims priority under 35 U.S.C. § 119 to Japanese Patent Application No. 2023-145428 filed on Sep. 7, 2023, and to Japanese Patent Application No. 2024-067798 filed on Apr. 18, 2024, the entire contents of which are being incorporated herein by reference.

### TECHNICAL FIELD

The present disclosure relates to a cycle time calculation apparatus which calculates a processing time by a machining cell.

### BACKGROUND

In the related art, there is known a machining cell that has a plurality of work resources (for example, JP 2022-077910 A). Each of the work resources applies a certain process on a workpiece, and, for example, the work resources correspond to a processing machine which cuts and machines a workpiece, a robot which transports a workpiece, and the like. With the use of such a machining cell, a plurality of workpieces can be produced efficiently.

Among the machining cells, there exist machining cells which dynamically determine timings of start of operations of a plurality of work resources based on an operation state of each of the plurality of work resources. In this case, the machining cell may sometimes operate two or more work resources in parallel with each other, depending on the operation states of the plurality of work resources.

Here, in order for an operator to determine a plan or to judge whether nor not a sequence program needs to be improved, there is a demand to know in advance time required for executing all of the processes designated in the sequence program (hereinafter referred to as a “cycle time”). However, in the case of the machining cell described above, it is difficult to predict in advance the timing of start of each process, and, depending on the situations, a plurality of processes may be executed in parallel with each other. Because of this, it is not possible to accurately calculate the cycle time by simply adding presumed times of the processes.

Naturally, the accurate cycle time can be determined by actually executing the sequence program. However, in this case, the machining process on the workpiece must be actually executed in order to calculate the cycle time, which consequently results in wastes. In particular, when correction of the sequence program is repeated in accordance with the cycle time, the workpiece must be actually machined every time of correction, and thus, a large amount of waste results.

In view of the above, an advantage of the present disclosure lies in the provision of a cycle time calculation apparatus which can virtually calculate the cycle time.

### SUMMARY

According to one aspect of the present disclosure, there is provided a cycle time calculation apparatus comprising: one or more processors; and a memory, wherein the one or more processors are configured to function as: a plurality of resource process units, each provided in correspondence to each of a plurality of work resources forming a machining cell, wherein each of the plurality of resource process units virtually judges progress of a process in a corresponding work resource based on an elapsed time from reception of a command to start a process, and outputs a result of the judgment as a resource state; a process control unit which dynamically determines timings to start operations of the plurality of work resources based on a sequence program designated by an operator and the resource states of the plurality of resource process units, and sends a command to start a process to the resource process unit in accordance with a result of the determination; a cumulative management unit which measures a time in which the resource state of at least one of the resource process units is in-operation; and a cycle time calculation unit which calculates a cycle time, which is a time required for actually executing machining in accordance with the sequence program, based on a result of the measurement by the cumulative management unit.

In this case, the resource process unit may calculate a process time based on the elapsed time from the reception of the command to start the process, and the resource process unit may judge that the process in the corresponding work resource is completed when the process time has reached a resource setting time which is predefined.

The resource process unit may calculate, as the process time, a value obtained by adding a product of all or a part of the elapsed time from the reception of the command to start the process and an acceleration factor which is predefined, and a remaining time of the elapsed time from the reception of the command to start the process, and the cycle time calculation unit may calculate, as the cycle time, a value obtained by adding a product of all or a part of a measured time by the cumulative management unit and the acceleration factor, and a remaining time of the measured time.

The resource process unit may include: a resource preparatory process unit which virtually judges progress of a preparatory process in the corresponding work resource; and a resource operative process unit which virtually judges progress of an operative process executed by the corresponding work resource after the preparatory process, the resource preparatory process unit may measure an elapsed time from reception of a command to start a process as a resource preparatory process time, and judge that the preparatory process is completed when the resource preparatory process time has reached a resource preparatory setting time which is predefined, the resource operative process unit may measure an elapsed time from reception of a command to start a process in a separated manner, either as a resource operative process time or the resource preparatory process time, and judge that the operative process is completed when a resource operation shaping time, which is a total of a product of the resource operative process time and an acceleration factor which is predefined, and the resource preparatory process time, has reached a resource operative setting time which is predefined, the cumulative management unit may measure, as a cumulative operative process time, a time in which at least one of the resource operative process units is measuring the resource operative process time, and measure, as a cumulative preparatory process time, a time in which at least one of the resource preparatory process units is measuring the resource preparatory process time, and the cycle time calculation unit may calculate, as the cycle time, a total of a product of the cumulative operative process time and the acceleration factor, and the cumulative preparatory process time.

In this case, the one or more processors may be further configured to function as a process switching unit, and, when the resource state of at least one of the resource preparatory process units is in-operation, the process switching unit may send a command to the resource operative process unit which is currently in operation, to measure an elapsed time from reception of a command to start a process as the resource preparatory process time, and may send a command to the cumulative operative management unit, to temporarily stop the measurement of the cumulative operative process time.

The resource process unit may include: a resource preparatory process unit which virtually judges progress of a preparatory process in the corresponding work resource; and a resource operative process unit which virtually judges progress of an operative process executed by the corresponding work resource after the preparatory process, the resource preparatory process unit may measure an elapsed time from reception of a command to start a process as a resource preparatory process time, and judge that the preparatory process is completed when the resource preparatory process time has reached a resource preparatory setting time which is predefined, the resource operative process unit may measure an elapsed time from reception of a command to start a process as a resource operative process time, and judge that the operative process is completed when a product of the resource operative process time and an acceleration factor which is predefined has reached a resource operative setting time which is predefined, the cumulative management unit may include: a cumulative preparatory management unit which measures, as a cumulative preparatory process time, a time in which at least one of the resource preparatory process units is measuring the resource preparatory process time; and a cumulative operative management unit which measures, as a cumulative operative process time, a time in which at least one of the resource operative process units is measuring the resource operative process time, the cycle time calculation unit may calculate, as the cycle time, a total of a product of the cumulative operative process time and the acceleration factor, and the cumulative preparatory process time, and the resource operative process unit may temporarily stop the measurements of the resource operative process time and the cumulative operative process time during a period in which at least one of the resource preparatory process units is measuring the resource preparatory process time.

According to another aspect of the present disclosure, there is provided a cycle time calculation apparatus comprising: one or more processors; and a memory, wherein the one or more processors are configured to function as: a plurality of resource process units, each provided in correspondence to one of a plurality of work resources forming a machining cell, wherein each of the plurality of resource process units virtually judges progress of a process in a corresponding work resource based on an elapsed time from reception of a command to start a process, and outputs a result of the judgment as a resource state; a process control unit which dynamically determines timings to start operations of the plurality of work resources based on a sequence program designated by an operator and the resource states of the plurality of resource process units, and sends commands to start a process to the resource process unit in accordance with a result of the determination; a cumulative management unit which measures a time in which the resource state of at least one of the resource process units is in-operation; and a cycle time calculation unit which calculates a cycle time, which is a time required for actually executing machining in accordance with the sequence program, based on a result of the measurement by the cumulative management unit, the resource process unit calculates, as a process time, a value obtained by adding a product of all or a part of the elapsed time from the reception of the command to start the process and an acceleration factor which is predefined, and a remaining time of the elapsed time from the reception of the command to start the process, and further calculates, as an over-time, a value obtained by subtracting a resource operative setting time, which is predefined, from the process time, and the cycle time calculation unit calculates, as the cycle time, a value obtained by subtracting a cumulative value of the over-time from a cumulative value of the process time.

According to another aspect of the present disclosure, there is provided a cycle time calculation apparatus comprising: one or more processors; and a memory, wherein the one or more processors are configured to function as: a plurality of resource process units, each provided in correspondence to one of a plurality of work resources forming a machining cell, wherein each of the plurality of resource process units virtually judges progress of a process in a corresponding work resource based on an elapsed time from reception of a command to start a process, and outputs a result of the judgment as a resource state; a process control unit which dynamically determines timings to start operations of the plurality of work resources based on a sequence program designated by an operator and the resource states of the plurality of resource process units, and sends a command to start a process to the resource process unit in accordance with a result of the determination; a cumulative management unit which measures a time in which the resource state of at least one of the resource process units is in-operation; and a cycle time calculation unit which calculates a cycle time, which is a time required for actually executing machining in accordance with the sequence program, based on a result of the measurement by the cumulative management unit, the resource process unit calculates, as a process time, a value obtained by adding a product of all or a part of the elapsed time from the reception of the command to start the process and an acceleration factor which is predefined, and a remaining time of the elapsed time from the reception of the command to start the process, and the resource process unit completes the process to multiply all or a part of the elapsed time by the acceleration factor at a timing when a difference between a resource operative setting time which is predefined and the process time becomes less than a product of the acceleration factor and a control period, and then adds an actual elapsed time to the process time until the process time has reached the resource operative setting time.

According to an aspect of the present disclosure, the cycle time can be virtually calculated.

### BRIEF DESCRIPTION OF DRAWINGS

Embodiment(s) of the present disclosure will be described based on the following figures, wherein:

FIG. 1 is a schematic diagram showing structures of a cycle time calculation apparatus and a machining cell;

FIG. 2 is a diagram showing an example of a cycle in accordance with a sequence program;

FIG. 3 is a functional block diagram of the cycle time calculation apparatus;

FIG. 4 is a diagram showing a control flow of a process control unit;

FIG. 5 is a diagram showing a control flow of a resource process unit;

FIG. 6 is a functional block diagram of another cycle time calculation apparatus;

FIG. 7 is a diagram showing the first half of a control flow of a process control unit;

FIG. 8 is a diagram showing the second half of the control flow of the process control unit;

FIG. 9 is a diagram showing a control flow of a process switching unit;

FIG. 10 is a diagram showing a control flow of a resource preparatory process unit;

FIG. 11 is a diagram showing a control flow of a cumulative preparatory management unit;

FIG. 12 is a diagram showing a control flow of a resource operative process unit;

FIG. 13 is a diagram showing a control flow of a cumulative operative management unit;

FIG. 14 is an image diagram showing calculation of a cycle time Tc of the cycle shown in FIG. 2 by the cycle time calculation apparatus shown in FIG. 6;

FIG. 15 is a diagram showing an example in which a process order changes due to partial acceleration;

FIG. 16 is a functional block diagram of a part of another cycle time calculation apparatus;

FIG. 17 is a diagram showing a control flow of a resource operative process unit of the apparatus of FIG. 16;

FIG. 18 is a diagram showing a control flow of a cumulative over-time management unit of the apparatus of FIG. 16; and

FIG. 19 is a diagram showing a case in which a resource operative process time exceeds a resource operative setting time.

### DESCRIPTION OF EMBODIMENTS

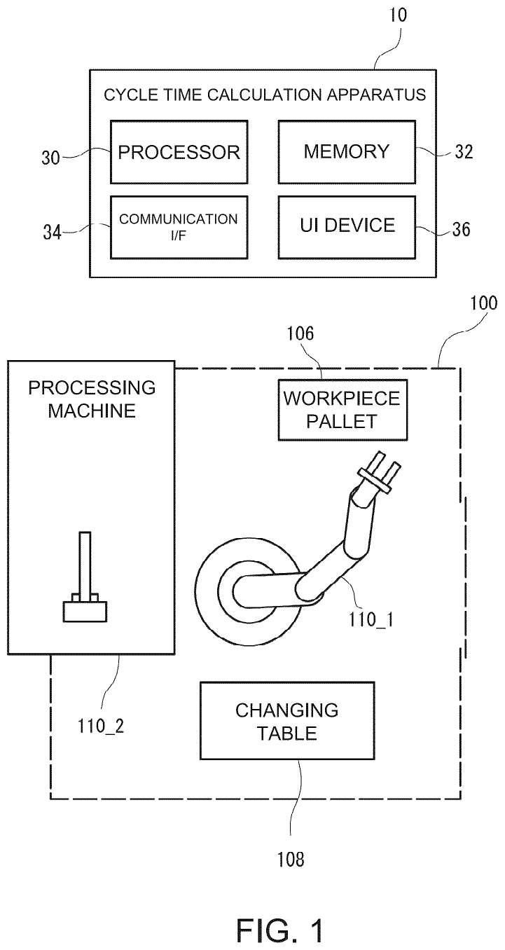

A structure of a cycle time calculation apparatus 10 will now be described with reference to the drawings. FIG. 1 is a schematic diagram showing structures of the cycle time calculation apparatus 10 and a machining cell 100.

The machining cell 100 has a first work resource 110_1 and a second work resource 110_2 and applies various machining on a workpiece. In the following description, when the first work resource 110_1 and the second work resource 110_2 are not distinguished, each of these work resources will be simply referred to as a “work resource 110”. This is similarly applied to descriptions of other members.

The machining cell 100 of the present configuration includes the first work resource 110_1 which is a robot, and the second work resource 110_2 which is a processing machine. The first work resource 110_1 (that is, the robot) grips and transports a workpiece. The second work resource 110_2 (that is, the processing machine) applies various cut-machining operations on a metal material. The machining cell 100 further includes a workpiece pallet 106 which stores a plurality of workpieces, and a changing table 108 on which a workpiece which is being transported is temporarily placed. The structure of the machining cell 100 described above is merely exemplary, and may be suitably changed. For example, as the work resource 110, in addition to or in place of the processing machine and the robot, another processing machine, another robot, a measurement apparatus, a machining apparatus, or the like may be included.

Operations of the machining cell 100 are controlled by a cell controller (not shown). Physically, the cell controller is a computer having one or more processors 30 and a memory 32. The cell controller sends a command to the work resource 110 which is a part of the machining cell 100, in order to produce a necessary number of products of necessary items, in accordance with a sequence program designated by an operator. In the sequence program, contents of a plurality of processes necessary for production of the product, execution condition of each process, and priority rank of each process are recorded. For example, for a “process of machining a workpiece with a processing machine”, an execution condition is set that the process is executed after a “process of transporting, with a robot, a workpiece to a processing machine”. In addition, the sequence program defines the priority rank of each process. For example, a case is considered in which a priority rank of a certain process I is set higher than a priority rank of another process II. In this case, when both the process I and the process II can be executed, the cell controller executes the process I with a higher priority. The cell controller monitors operation states of a plurality of work resources 110, and dynamically determines orders of execution of the processes and timings of starting the execution in accordance with the operation states. In the following, a series of processes to produce, by the machining cell, the necessary number of products of items designated by the operator in accordance with the sequence program will be referred to as a “cycle”, and a process time required for execution of the cycle will be referred to as a “cycle time Tc”.

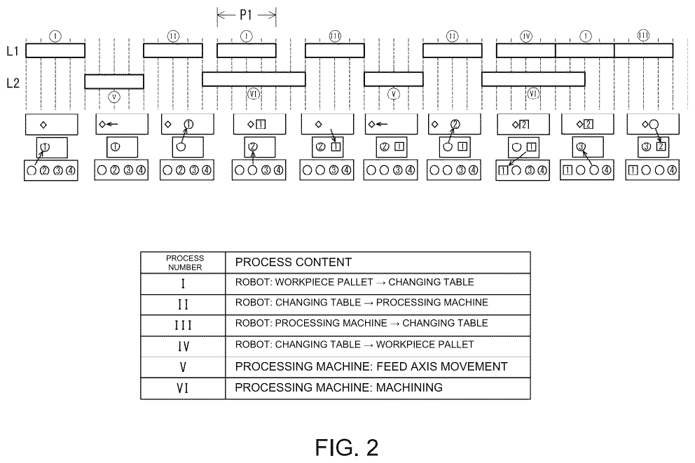

An example of the cycle in accordance with the sequence program will now be described with reference to FIG. 2. A first line L1 in FIG. 2 shows the processes executed by the first work resource 110_1 (that is, the robot), and a second line L2 in FIG. 2 shows processes executed by the second work resource 110_2 (that is, the processing machine).

As shown in FIG. 2, the first work resource 110_1 executes processes I to IV for transporting a plurality of workpieces among the workpiece pallet 106, the changing table 108, and the processing machine. The second work resource 110_2 executes a process V to move a feed axis of the processing machine prior to acceptance of the workpiece, and a process VI to apply cut-machining on the accepted workpiece.

The order of execution of the processes and timings of starting the processes are dynamically determined by the cell controller in accordance with the operation states of the work resources 110 and the priority ranks of the processes. In parallel with a process on one workpiece, a process for another workpiece is executed. For example, in the case of FIG. 2, during a period P1, the machining process (process VI) for a first workpiece and the transporting process (process I) of a second workpiece are executed in parallel with each other.

There is a demand for knowing in advance a time required for such a series of the cycle; that is, the cycle time Tc. By knowing the cycle time Tc in advance, the operator can determine a plan or consider correction of the sequence program. However, because the order of execution and the timings of start of the plurality of processes are dynamically determined by the cell controller as described above, it is difficult for the operator to know this information in advance. In addition, because, in many cases, a plurality of processes are executed in parallel with each other, an accurate cycle time Tc cannot be obtained by simply adding approximate times of the processes.

Naturally, the accurate cycle time Tc can be obtained by actually operating the machining cell 100 in accordance with the sequence program, to thereby actually machine the workpiece. However, actually machining the workpiece just for the sake of knowing the cycle time Tc is not efficient. In addition, when the sequence program is to be corrected in consideration of the cycle time Tc, the workpiece must be actually machined every time the sequence program is corrected, which is very inefficient.

The cycle time calculation apparatus 10 is an apparatus which obtains the cycle time Tc without executing the machining of the workpiece by the machining cell 100. As shown in FIG. 1, the cycle time calculation apparatus 10 is a computer having the one or more processors 30, the memory 32, a communication I/F 34, and a UI device 36. The communication I/F 34 executes data communication with other devices (for example, the cell controller, a personal computer manipulated by the operator, and the like) as necessary. The UI device 36 receives commands from the operator, and submits information to the operator. For this purpose, the UI device 36 includes an input device such as a keyboard, a touch panel, a mouse, and a microphone, and an output device such as a display and a speaker. The calculated cycle time Tc and the timings to start the processes calculated by a process to be described later are provided to the operator via the UI device 36.

In FIG. 1, the cycle time calculation apparatus 10 is shown as a single computer independent from the machining cell 100. Alternatively, the cycle time calculation apparatus 10 may be formed by combining a plurality of computers provided in a physically separated manner. Alternatively, a part or the entirety of the cycle time calculation apparatus 10 may be incorporated in the machining cell 100. For example, the cell controller may function as a part or entirety of the cycle time calculation apparatus 10.

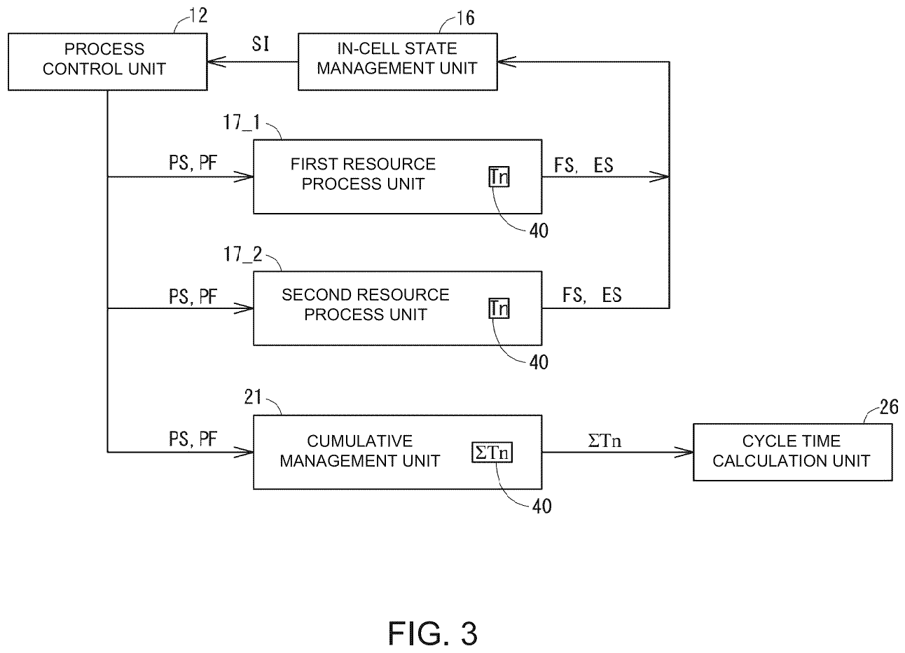

FIG. 3 is a functional block diagram of the cycle time calculation apparatus 10. The cycle time calculation apparatus 10 comprises a first resource process unit 17_1, a second resource process unit 17_2, an in-cell state management unit 16, a process control unit 12, a cumulative management unit 21, and a cycle time calculation unit 26.

The first resource process unit 17_1 and the second resource process unit 17_2 have the same basic structure, and thus, in the following description, the resource process units will not be distinguished, and each will be called “resource process unit 17”. Each of the resource process units 17 is provided in correspondence to one of the plurality of work resources 110 of the machining cell 100. Therefore, the first resource process unit 17_1 corresponds to the first work resource 110_1, and the second resource process unit 17_2 corresponds to the second work resource 110_2.

The resource process unit 17 virtually judges and outputs progress of a process in the corresponding work resource 110. For the judgment of the progress, the resource process unit 17 stores in advance a process time of a process executed by the corresponding work resource 110 as a resource setting time T*. For example, the first resource process unit 17_1 stores, as the resource setting times T*, a process time of the process I in FIG. 2, a process time of the process II, and a process time of the process III. The resource setting time T* may be obtained by actually operating the first work resource 110_1 in advance, or may be logically calculated through some simulation or calculation.

The resource process unit 17 also has a timer 40 which counts an elapsed time from reception of a process start signal PS from the process control unit 12. When the resource process unit 17 starts the count by the timer 40, the resource process unit 17 outputs an execution signal ES indicating the start of operation to the in-cell state management unit 16. The resource process unit 17 also outputs the elapsed time counted by the timer 40 as a resource process time Tn. The resource process time Tn is a virtual operation time of the corresponding work resource 110.

The resource process unit 17 compares the resource process time Tn which is output, and the resource setting time T*, and outputs a completion signal FS indicating completion of the process to the in-cell state management unit 16 when the resource process time Tn becomes greater than or equal to the resource setting time T*. Further, when Tn becomes greater than or equal to T* (Tn≥T*), the resource process unit 17 stops the count by the timer 40 and resets the timer 40.

In the present configuration, the actual elapsed time is presumed as the resource process time Tn. However, in some cases, a value obtained by multiplying the actual elapsed time by an acceleration factor K which is predefined may be presumed as the resource process time Tn. That is, when the elapsed time is Ta, Tn may be determined as Tn=K×Ta. By employing such a structure, the judgment of the progress of each process can be accelerated, and, as a consequence, the time required for calculation of the cycle time Tc can be significantly shortened. In the following description, the process of presuming the value obtained by multiplying the elapsed time by the acceleration factor K as the resource process time Tn will be referred to as “acceleration”. No particular limitation is imposed on the acceleration factor K, and, for example, the operator may set an arbitrary value between 1 and about 2000.

The in-cell state management unit 16 manages a state of each of the plurality of resource process units 17 (hereinafter, referred to as a “resource state SI”). Specifically, the in-cell state management unit 16 manages flags for the plurality of resource process units 17. When the in-cell state management unit 17 receives the execution signal ES from one resource management unit 17, the in-cell state management unit 17 switches a flag corresponding to this resource process unit 17 to High, and, when the in-cell state management unit 16 receives the completion signal FS, the in-cell state management unit 16 switches the flag corresponding to the resource process unit 17 to Low. Thus, when the flag is High, it can be judged that the corresponding resource process unit 17 is virtually in operation.

The process control unit 12 dynamically determines timings for starting operations for the plurality of work resources 110, and outputs a process start signal PS to the resource process unit 17 in accordance with a result of the determination. More specifically, the process control unit 12 monitors, in a predetermined control period, the resource states SI managed by the in-cell state management unit 16. The process control unit 12 determines the start timing for each of the plurality of processes based on the resource states SI and the sequence program designated by the operator. An algorithm for determining the timing is identical to an algorithm equipped in the cell controller. Therefore, the cell controller equipped in the machining cell 100 may be used as the process control unit 12.

When the process control unit 12 judges that starting one process is necessary, the process control unit 12 outputs the process start signal PS to the resource process unit 17 corresponding to the process, and to the cumulative management unit 21 to be described later. In addition, when all processes defined in the sequence program are completed, the resource process unit 17 outputs a process completion signal PF to the cumulative management unit 21.

The cumulative management unit 21 counts a time in which at least one of the resource process units 17 is in operation. For this counting, the cumulative management unit 21 has the timer 40, and outputs the time measured by the timer 40 to the cycle time calculation unit 26 as a cumulative process time ΣTn. The cycle time calculation unit 26 calculates the cycle time Tc required for actually executing the sequence program, based on the cumulative process time ΣTn.

When the acceleration is not applied to the calculation of the resource process time Tn; that is, when the elapsed time Ta is presumed as the resource process time Tn, Tc=ΣTn=Ta. On the other hand, when the acceleration is applied to the calculation of the resource process time Tn; that is, when Tn=K×Ta, Tc=ΣTn=Σ(K×Ta).

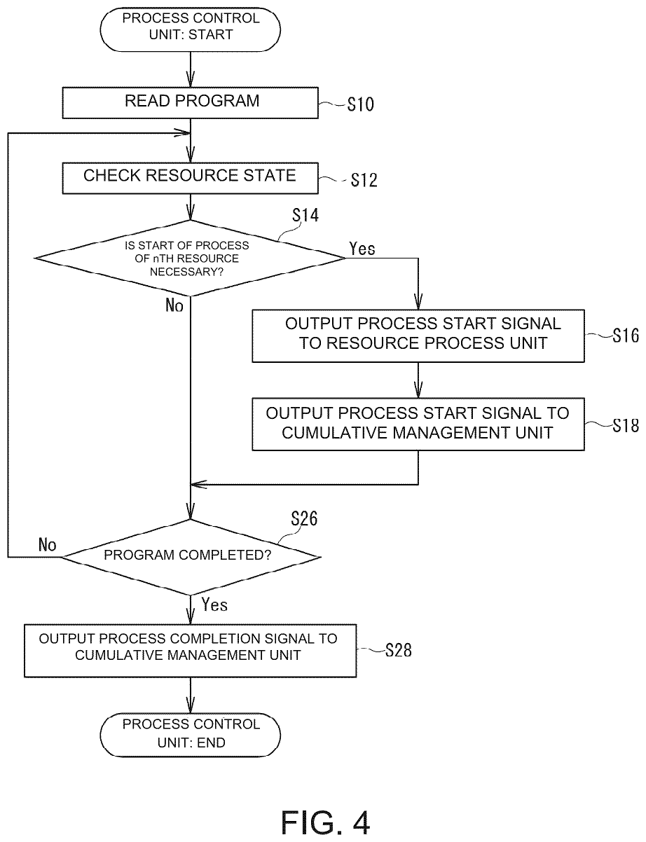

Next, a control flow of cycle time calculation by the cycle time calculation apparatus 10 will be described. FIG. 4 shows a control flow of the process control unit 12. The process control unit 12 first reads the sequence program designated by the operator (S10). The process control unit 12 checks the resource state SI of each of the plurality of resource process units 17, managed by the in-cell state management unit 16 (S12).

Then, the process control unit 12 executes steps shown in steps S16 to S28. These steps are executed for the plurality of resource process units 17 in parallel with each other. Specifically, the process control unit 12 judges whether or not a process related to an nth resource process unit 17_n is to be started based on the sequence program and the resource state SI (S14). When it is judged as a result of the judgment that start of the process is necessary, the process control unit 12 outputs the process start signal PS to the nth resource process unit 17_n and to the cumulative management unit 21 (S16, S18). After the process start signal PS is output, or when it is not necessary to start the process, the process control unit 12 judges whether or not all of processes commanded in the sequence program have been completed (S26). When the processes are not completed, the process control unit 12 returns to step S12, and repeats a similar process. On the other hand, when the sequence program is completed, the process control unit 12 outputs the process completion signal PF to the cumulative management unit 21 (S28).

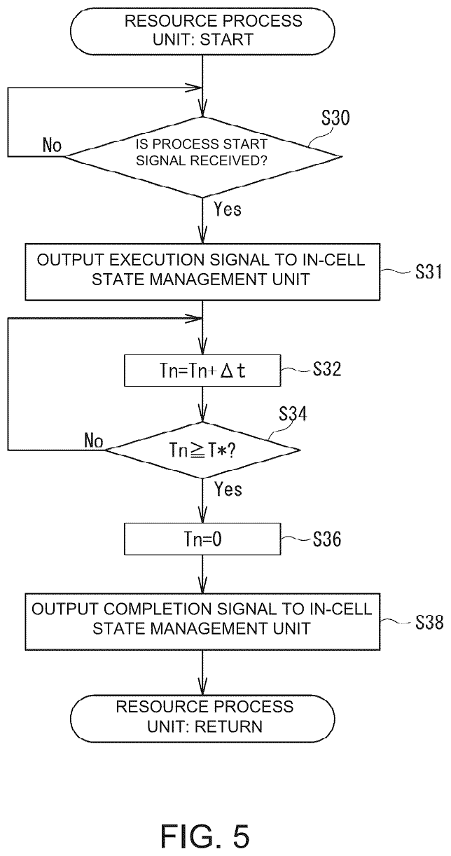

Next, a control flow of the resource process unit 17 will be described with reference to FIG. 5. In FIG. 5, the acceleration is not applied in the calculation of the resource process time Tn, and the elapsed time Ta is presumed as the resource process time Tn. The resource process unit 17 stands by until reception of the process start signal PS from the process control unit 12 (S30). When the process start signal PS is received, the resource process unit 17 outputs the execution signal ES to the in-cell state management unit 16 (S31). With this process, the in-cell state management unit 16 switches a flag corresponding to this resource process unit 17 to High, which indicates “in-operation”.

Then, the resource process unit 17 adds a control period Δt, which is predefined, to the current resource process time Tn (S32). This addition process is repeated until the resource process time Tn becomes greater than or equal to the resource setting time T* which is predefined (S34). Here, the resource setting time T* may be changed depending on the type of the process. In this case, the resource process unit 17 stores an identification number of the process and the resource setting time T* of the process in correspondence to each other. In addition, the process control unit 12 outputs, along with the process start signal PS, an identification number of a process to be started, to the resource process unit 17.

When Tn becomes greater than or equal to T*(Tn≥T*), the resource process unit 17 resets the resource process time Tn to “0” (S36). The resource process unit 17 also outputs the completion signal FS to the in-cell state management unit 16 (S38). With this process, the in-cell state management unit 16 switches the flag corresponding to this resource process unit 17 to Low, which indicates “stand-by”. Then, the resource process unit 17 returns to step S30, and stands by until the process start signal PS is again received. In this manner, the resource process unit 17 can output a virtual progress situation of each process by monitoring the elapsed time Ta from the reception of the process start signal PS.

The cumulative management unit 21 measures, as the cumulative process time ΣTn, a time after the process start signal PS is received from the process control unit 12, and until the process completion signal PF is received. The cycle time calculation unit 26 calculates the cycle time Tc from the cumulative process time ΣTn.

As is clear from the above description, in the present configuration, the order of execution and the timings of start of the plurality of processes are judged using an algorithm identical to that of the actual machining cell 100. The process time is measured while virtually judging the progress situation of the plurality of processes. As a result, according to the present configuration, the cycle time Tc can be calculated appropriately without actually machining the workpiece. In addition, in the above-described example configuration, the actual elapsed time Ta is presumed as the resource process time Tn, but by treating a value obtained by multiplying the elapsed time Ta by the acceleration factor K as the resource process time Tn, the time required for calculating the cycle time Tc can be significantly shortened. As a result, consideration of the plans by the operator, correction of the sequence program, and the like can be more efficiently performed.

Next, a structure of another cycle time calculation apparatus 10 will be described. In the above description, progress of a process is judged without dividing a process. However, normally, a process includes a preparatory process and an operative process. The preparatory process is a process necessary until the work resource 110 actually operates, and includes, for example, a communication process between the cell controller and the work resource 110, and a selection command of an operation program. The operative process is a process to actually operate the work resource 110. Normally, a time required for the preparatory process is sufficiently shorter in comparison to a time required for the operative process. For example, while the time required for the preparatory process is about a few milliseconds to a few hundreds of milliseconds, the time required for the operative process is about a few seconds to a few tens of minutes.

When the cycle time Tc is calculated, the resource process unit 17 judges the progress situation of the operative process from the elapsed time Ta without actually executing the operative process. Therefore, when the progress of the operative process is judged, the above-described acceleration is applied. On the other hand, the resource process unit 17 executes a process similar to the actual preparatory process. That is, the resource process unit 17 communicates with the process control unit 12, and receives the selection command of the operation program. Because of this, it is difficult to apply the acceleration as described above, when judging the progress of the preparatory process.

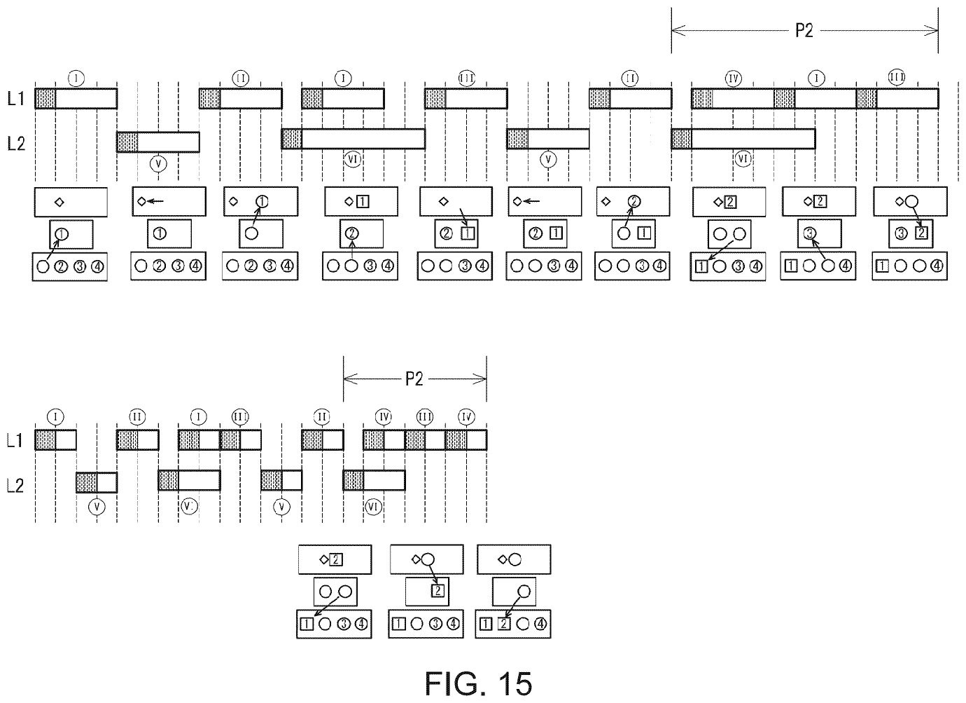

A configuration may be considered in which the progress is judged while applying the acceleration to the operative process and not applying the acceleration to the preparatory process. However, in this case, because the rate of elapse of time differs between the operative process and the preparatory process, a case may arise in which the execution order of the processes differs from the actual order of execution. This situation will now be described with reference to FIG. 15. FIG. 15 shows an example configuration in which the order of the processes changes due to partial acceleration. An upper part of FIG. 15 shows a cycle identical to the cycle shown in FIG. 2. A lower part of FIG. 15 shows a cycle in which, of the cycle of the upper part, the acceleration is applied only to the operative process. In the example configuration of FIG. 15, the operative process is measured in triple speed; that is, the acceleration factor K in the operative process is set to “3”. In addition, in FIG. 15, a gray-hatched band shows the preparatory process, and a solid-white band shows the operative process.

A period P2 in the case when the acceleration is not applied to the operative process (that is, the upper part of FIG. 15) is considered. In the first resource process unit 17_1, a process IV to transport the workpiece from the changing table 108 to the workpiece pallet 106 is virtually executed. In addition, in parallel with the process IV, the second resource process unit 17_2 virtually executes a process VI. The process VI is a process in which the processing machine machines the workpiece.

At the point of completion of the process IV, the process VI is still in progress. Because the process VI is a process in which the processing machine machines the workpiece, naturally, a process III in which the robot removes the workpiece from the processing machine cannot be executed in parallel with the process VI. Because of this, when the acceleration is not applied to the operative process, the first resource process unit 17_1 virtually starts the process I, not the process III, after the process IV is completed.

On the other hand, in the case in which the acceleration is applied only to the operative process, as shown in the period P2 in the lower part, at the point of completion of the process IV, the process VI is also completed. In this case, after the process IV, the process control unit 12 commands start of execution of the process III, not the process I. Thus, when the acceleration is applied only to the operative process, the processes are executed in an order different from that in the actual cycle, and there is a possibility that the cycle time Tc cannot be accurately calculated.

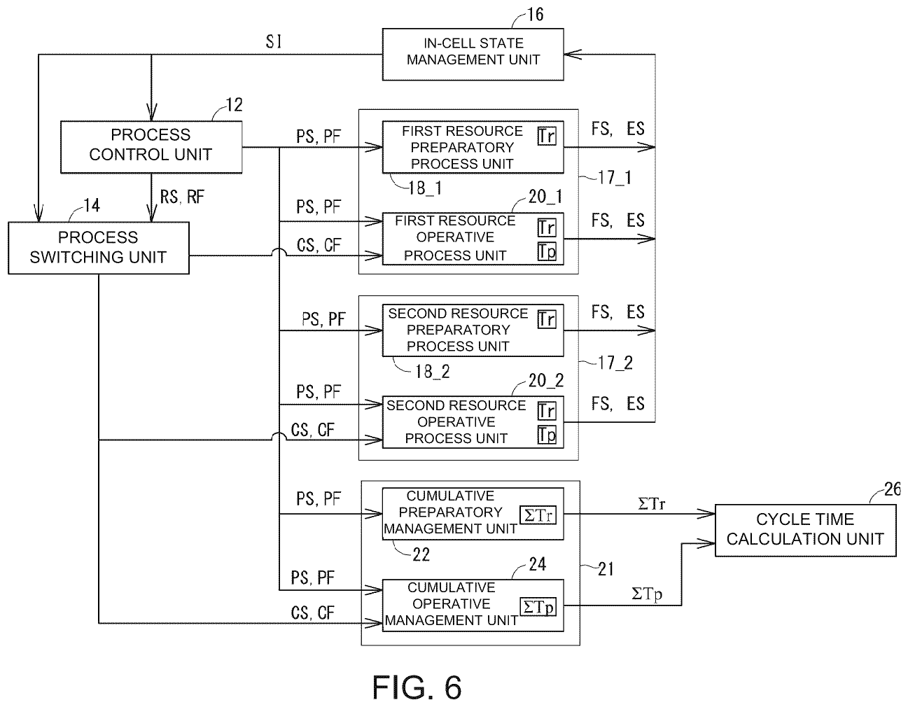

FIG. 6 is a functional block diagram of a cycle time calculation apparatus 10 for handling such a problem. The cycle time calculation apparatus 10 has a physical structure as shown in FIG. 1.

In the cycle time calculation apparatus 10 of FIG. 6, each resource process unit 17 includes a resource preparatory process unit 18 and a resource operative process unit 20. The resource preparatory process unit 18 virtually judges a progress situation of the preparatory process. Specifically, the resource preparatory process unit 18 measures the elapsed time from reception of the process start signal PS as a resource preparatory process time Tr. In addition, the resource preparatory process unit 18 stores in advance a resource preparatory setting time Tr*, which is time required for the preparatory process. The resource preparatory process unit 18 judges that the preparatory process is completed when the measured resource preparatory process time Tr becomes greater than or equal to the resource preparatory setting time Tr*. The resource preparatory process unit 18 outputs the execution signal ES and the completion signal FS to the in-cell state management unit 16 respectively when the process is started and when the process is completed.

The resource operative process unit 20 virtually judges a progress situation of the operative process. Specifically, the resource operative process unit 20 measures the elapsed time from the reception of the process start signal PS in a separated manner, either as a resource operative process time Tp or a resource preparatory process time Tr. The resource operative process unit 20 counts the elapsed time as the resource preparatory process time Tr when the resource state SI of at least one of the resource preparatory process units 18 is in-operation. On the other hand, when none of the resource preparatory process units 18 is in operation, the resource operative process unit 20 counts the elapsed time as the resource operative process time Tp. With such a configuration, as the cycle time calculation apparatus 10 as a whole, the resource operative process time Tp is not measured in parallel with the resource preparatory process time Tr. When the resource preparatory process time Tr is being measured in any of the resource preparatory process unit 18, the other resource operative process units 20 stop the measurement of the resource operative process time Tp, and measure the resource preparatory process time Tr. In order to enable such a measurement, the resource operative process unit 20 has two timers (in FIG. 6, the reference numerals are omitted).

The resource operative process unit 20 calculates a value obtained by adding a product of the resource operative process time Tp and the acceleration factor K, and the resource preparatory process time Tr as a resource operative shaping time Tpa. That is, Tpa=K×Tp+Tr. The resource operative process unit 20 judges that the operative process is completed when the resource operative shaping time Tpa becomes greater than or equal to a resource operative setting time Tp*. Similar to the resource preparatory process unit 18, the resource operative process unit 20 outputs the execution signal ES and the completion signal FS to the in-cell state management unit 16 respectively when the process is started and when the process is completed.

The cumulative management unit 21 measures a cumulative value of the time in which at least one of the plurality of resource process units 17 is in operation in a separated manner, either as a cumulative preparatory process time ΣTr or a cumulative operative process time ΣTp. More specifically, the cumulative management unit 21 includes a cumulative preparatory management unit 22, and a cumulative operative management unit 24. The cumulative preparatory management unit 22 measures a time in which the resource preparatory process time Tr is counted in any of the resource preparatory process units 18, as the cumulative preparatory process time ΣTr. The cumulative operative management unit 24 measures a time in which the resource operative process time Tp is counted in any of the resource operative process units 20, as the cumulative operative process time ΣTp.

The cycle time calculation unit 26 calculates, as the cycle time Tc, a value obtained by adding a product of the cumulative operative process time ΣTp and the acceleration factor K, and the cumulative preparatory process time ΣTr. Thus, Tc=K×ΣTp+ΣTr.

The process control unit 12 dynamically determines the timings of starting the preparatory processes and the operative processes of the plurality of work resources 110, and outputs the process start signal PS to the resource preparatory process unit 18 and to the resource operative process unit 20 in accordance with a result of the determination. The process control unit 12 further outputs a preparatory process start signal RS to the process switching unit 14 at the timing of start of the preparatory process, and outputs a preparatory process completion signal RF to the process switching unit 14 at the timing of completion of the preparatory process.

The process switching unit 14 commands switching of a counting form to the resource operative process unit 20 and the cumulative operative management unit 24. That is, as described above, the resource operative process unit 20 measures the elapsed time from the start of the process in a separated manner, either as the resource operative process time Tp or the resource preparatory process time Tr. Further, the cumulative operative management unit 24 must stop the measurement of the cumulative operative process time ΣTp during a period in which any of the resource preparatory process units 18 is in operation. The process switching unit 14 commands the switching of the measurement form to the resource operative process unit 20 and the cumulative operative management unit 24.

Specifically, when the process switching unit 14 receives the preparatory process start signal RS from the process control unit 12, the process switching unit 14 outputs a preparatory time start signal CS to the resource operative process unit 20 which is currently in operation and to the cumulative operative management unit 24. When the resource operative process unit 20 receives the preparatory time start signal CS, the resource operative process unit 20 stops the measurement of the resource operative process time Tp, and starts measurement of the resource preparatory process time Tr. When the cumulative operative management unit 24 receives the preparatory time start signal CS, the cumulative operative management unit 24 temporarily stops the measurement of the cumulative operative process time ΣTp.

When the process switching unit 14 receives the preparatory process completion signal RF from the process control unit 12, the process switching unit 14 outputs a preparatory time completion signal CF to the resource operative process unit 20 which is currently in operation and to the cumulative operative management unit 24. When the resource operative process unit 20 receives the preparatory time completion signal CF, the resource operative process unit 20 stops the measurement of the resource preparatory process time Tr, and starts the measurement of the resource operative process time Tp. When the cumulative operative management unit 24 receives the preparatory time completion signal CF, the cumulative operative management unit 24 restarts the measurement of the cumulative operative process time ΣTp.

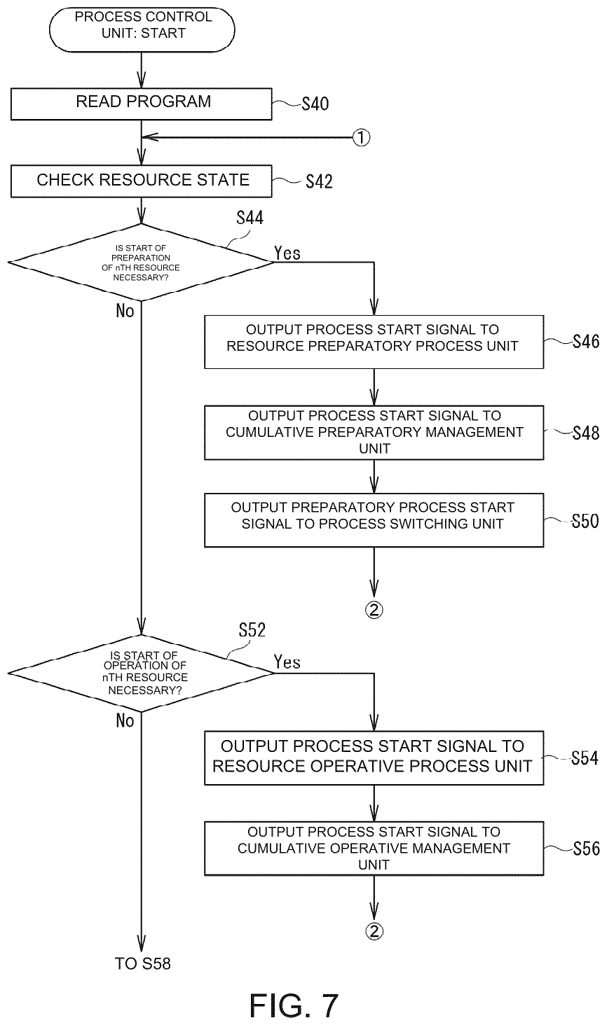

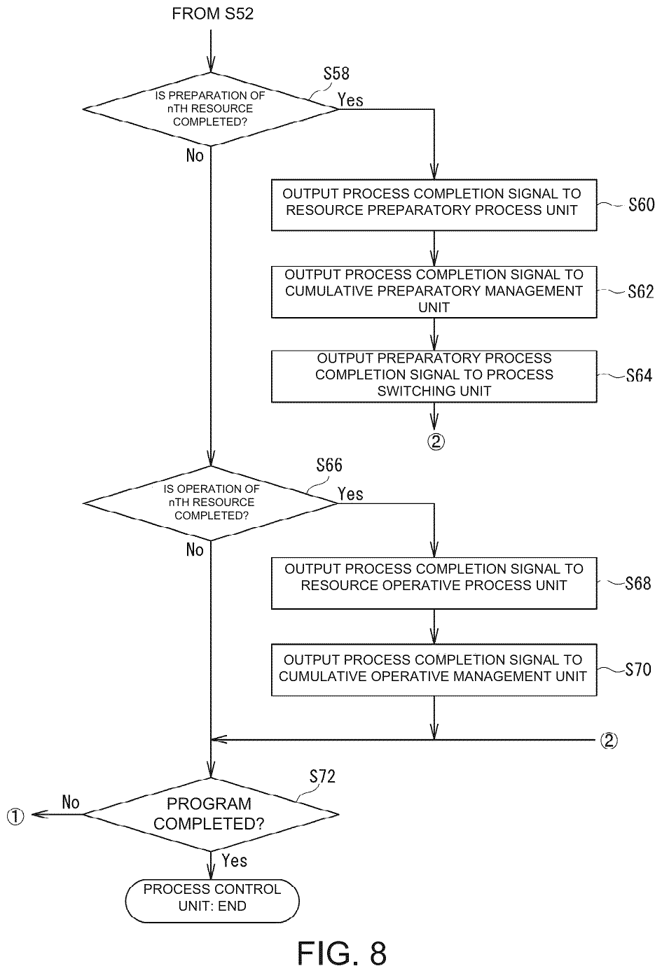

Next, a control flow of the cycle time calculation by the cycle time calculation apparatus 10 shown in FIG. 6 will be described. FIG. 7 and FIG. 8 show the control flow of the process control unit 12. Similar to the case of FIG. 4, the process control unit 12 first reads the sequence program designated by the operator (S40). Then, the process control unit 12 executes the steps described in steps S42 to S72. The steps S42 to S72 are executed for the plurality of resource process units 17 in parallel with each other. In step S42, the process control unit 12 checks the resource states SI managed by the in-cell state management unit 16.

Then, the process control unit 12 judges whether or not a preparatory process of the process for an nth resource process unit 17_n is to be started, based on the sequence program and the resource state SI (S44). When it is judged as a result of the judgment that start of the preparatory process is necessary, the process control unit 12 outputs the process start signal PS to the nth resource preparatory process unit 18_n and to the cumulative preparatory management unit 22 (S46, S48). The process control unit 12 also outputs the preparatory process start signal RS to the process switching unit 14 (S50), and then proceeds to step S72.

The process control unit 12 also judges whether or not an operative process of the process for the nth resource process unit 17_n is to be started (S52). When start of the operative process is necessary, the process control unit 12 outputs the process start signal PS to the nth resource operative process unit 20_n and to the cumulative operative management unit 24 (S54, S56), and then proceeds to step S72.

The process control unit 12 also judges whether or not the preparatory process of the process for the nth resource process unit 17_n is completed (S58). When the preparatory process is completed, the process control unit 12 outputs the process completion signal PF to the nth resource preparatory process unit 18_n and to the cumulative preparatory management unit 22 (560, S62). The process control unit 12 also outputs the preparatory process completion signal RF to the process switching unit 14 (S64), and then proceeds to step S72.

The process control unit 12 also judges whether or not the operative process of the process for the nth resource process unit 17_n is completed (S66). When the operative process is completed, the process control unit 12 outputs the process completion signal PF to the nth resource operative process unit 20_n and to the cumulative operative management unit 24 (568, S70), and then proceeds to step S72.

In step S72, the process control unit 12 checks whether or not the sequence program is completed. When it is judged as a result of the checking that the sequence program is not completed, the process control unit 12 returns to step S42. When the sequence program is completed, the control flow of the process control unit 12 is completed.

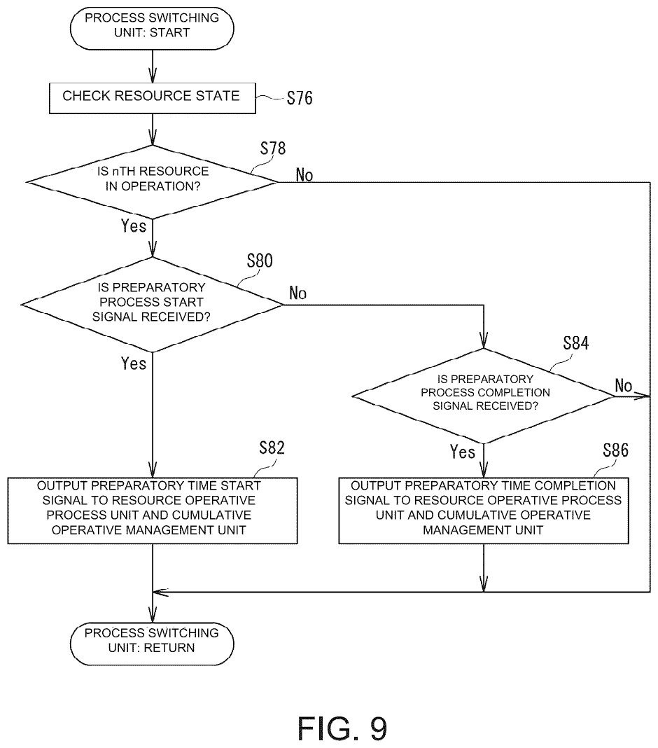

Next, a control flow of the process switching unit 14 will be described with reference to FIG. 9. The process switching unit 14 checks the resource state SI recorded in the in-cell state management unit 16 (S76). Then, the process switching unit 14 executes steps S78 to S86 for the plurality of resource process units 17 in parallel with each other. That is, the process switching unit 14 checks whether or not an nth resource operative process unit 20_n is in operation (S78). When the resource operative process unit is not in operation, the process switching unit 14 returns to the start of the flow (that is, step S76), and continues to check the resource state SI.

On the other hand, when the nth resource operative process unit 20_n is in operation, the process switching unit 14 checks whether or not the preparatory process start signal RS is received (S80). When the preparatory process start signal RS is received, the process switching unit 14 outputs the preparatory time start signal CS to the nth resource operative process unit 20_n and to the cumulative operative management unit 24 (S82).

When the preparatory process start signal RS is not received in step S80, the process switching unit 14 checks whether or not the preparatory process completion signal RF is received (S84). When the preparatory process completion signal RF is received, the process switching unit 14 outputs the preparatory time completion signal CF to the nth resource operative process unit 20_n and to the cumulative operative management unit 24 (S86).

On the other hand, when neither the preparatory process start signal RS nor the preparatory process completion signal RF is received, the process switching unit 14 returns to the start of the flow, and continues to check the resource state SI.

In other words, the process switching unit 14 outputs, when the preparatory process is started or completed in any of the resource preparatory process units 18 when any of the resource operative process units 20 is in operation, the signal RS or RF notifying the start or completion of the preparatory process, to the resource operative process unit 20 and to the cumulative operative management unit 24.

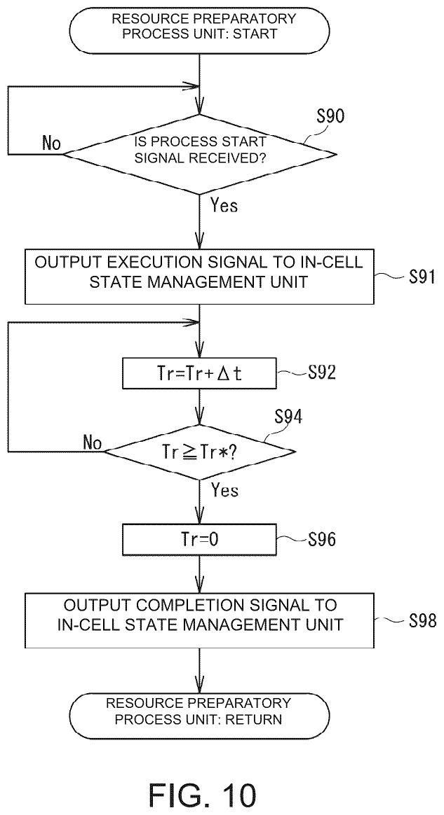

Next, a control flow of the resource preparatory process unit 18 will be described with reference to FIG. 10. When the resource preparatory process unit 18 receives the process start signal PS from the process control unit 12 (Yes in S90), the resource preparatory process unit 18 outputs the execution signal ES to the in-cell state management unit 16 (S91). Then, the resource preparatory process unit 18 starts measurement of the resource preparatory process time Tr. That is, the resource preparatory process unit 18 adds the control period Δt to the current resource preparatory process time Tr (S92). When the resource preparatory process time Tr becomes greater than or equal to the resource preparatory setting time Tr* which is set in advance (Yes in S94), the resource preparatory process unit 18 resets the resource preparatory process time Tr to 0 (S96), and outputs the completion signal FS to the in-cell state management unit 16 (S98). The resource preparatory process unit 18 repeats the processes described above, until the sequence program is completed.

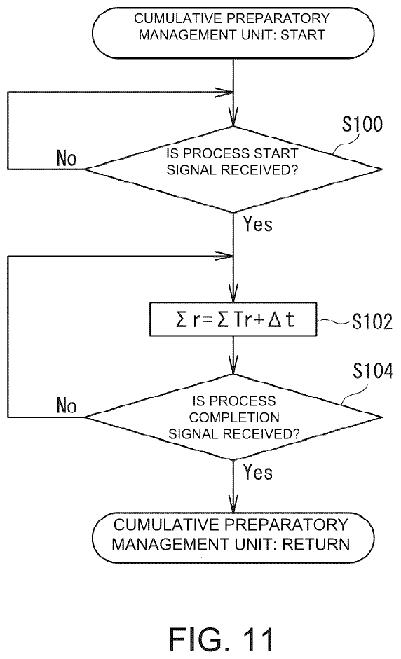

Next, a control flow of the cumulative preparatory management unit 22 will be described with reference to FIG. 11. When the cumulative preparatory management unit 22 receives the process start signal PS from the process control unit 12 (Yes in S100), the cumulative preparatory management unit 22 starts the measurement of the cumulative preparatory process time ΣTr. That is, the cumulative preparatory management unit 22 continues to add the control period Δt to the current cumulative preparatory process time ΣTr (S102). During this process, when the process completion signal PF is received from the process control unit 12 (Yes in S104), the cumulative preparatory management unit 22 stops the measurement of the cumulative preparatory process time ΣTr and returns to the start of the flow (that is, step S100). In other words, the cumulative preparatory management unit 22 stops the measurement of the cumulative preparatory process time ΣTr when the process completion signal PF is received, until the process start signal PS is again received.

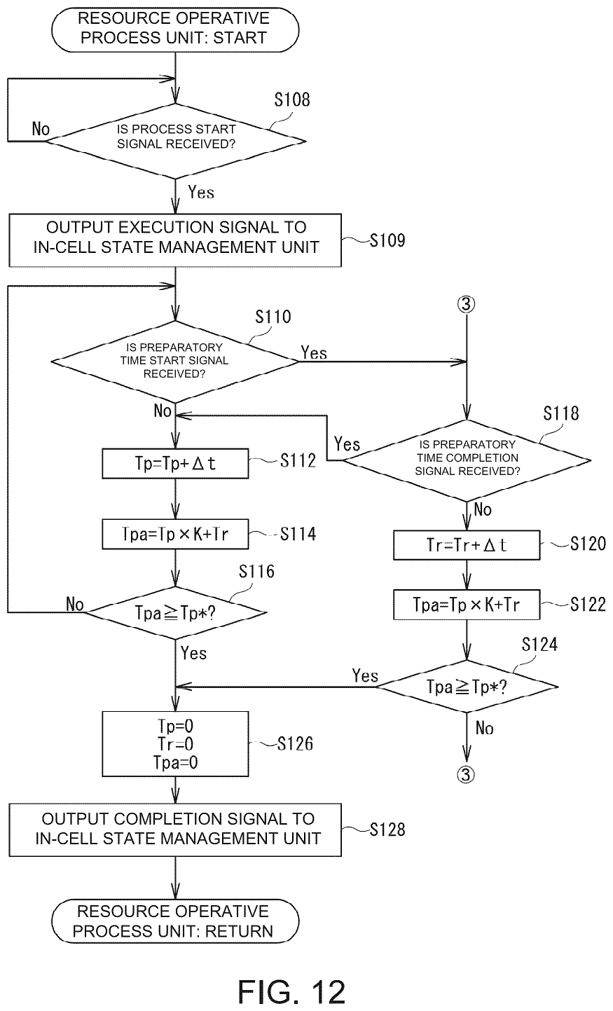

Next, a control flow of the resource operative process unit 20 will be described with reference to FIG. 12. When the resource operative process unit 20 receives the process start signal PS from the process control unit 12 (Yes in S108), the resource operative process unit 20 outputs the execution signal ES to the in-cell state management unit 16 (S109). Then, the resource operative process unit 20 measures the elapsed time in a separated manner, either as the resource operative process time Tp or the resource preparatory process time Tr (S110 to S124). More specifically, the resource operative process unit 20 checks whether or not the preparatory time start signal CS is received (S110). When the preparatory time start signal CS is not received (No in S110), the resource operative process unit 20 measures the elapsed time as the resource operative process time Tp. That is, the resource operative process unit 20 calculates a value obtained by adding the control period Δt to the current resource operative process time Tp as a new resource operative process time Tp (S112).

Then, the resource operative process unit 20 calculates the resource operative shaping time Tpa (S114). The resource operative shaping time Tpa is a value obtained by adding a product of the new resource operative process time Tp and the acceleration factor K which is predefined, and the current resource preparatory process time Tr. When the resource operative shaping time Tpa is less than the resource operative setting time Tp* which is predefined (No in S116), the resource operative process unit 20 returns to step S110.

On the other hand, when the preparatory time start signal CS is received in step S110, the resource operative process unit 20 next checks whether or not the preparatory time completion signal CF is received (S118). When the preparatory time completion signal CF is not received, the resource operative process unit 20 measures the elapsed time as the resource preparatory process time Tr. That is, the resource operative process unit 20 calculates a value obtained by adding the control period Δt to the current resource preparatory process time Tr as a new resource preparatory process time Tr (S120). Then, the resource operative process unit 20 calculates the resource operative shaping time Tpa (S122), and compares the resource operative shaping time Tpa with the resource operative setting time Tp* (S124). When Tpa<Tp*, the resource operative process unit 20 returns to step S118, and continues to measure the resource preparatory process time Tr.

When the resource operative shaping time Tpa becomes greater than or equal to the resource operative setting time Tp* in step S116 or in step S124, the resource operative process unit 20 resets all of the resource operative process time Tp, the resource preparatory process time Tr, and the resource operative shaping time Tpa to 0 (S126). Then, the resource operative process unit 20 outputs the completion signal FS to the in-cell state management unit 16 (S128). Then, the resource operative process unit 20 repeats the processes of steps S108 to S128.

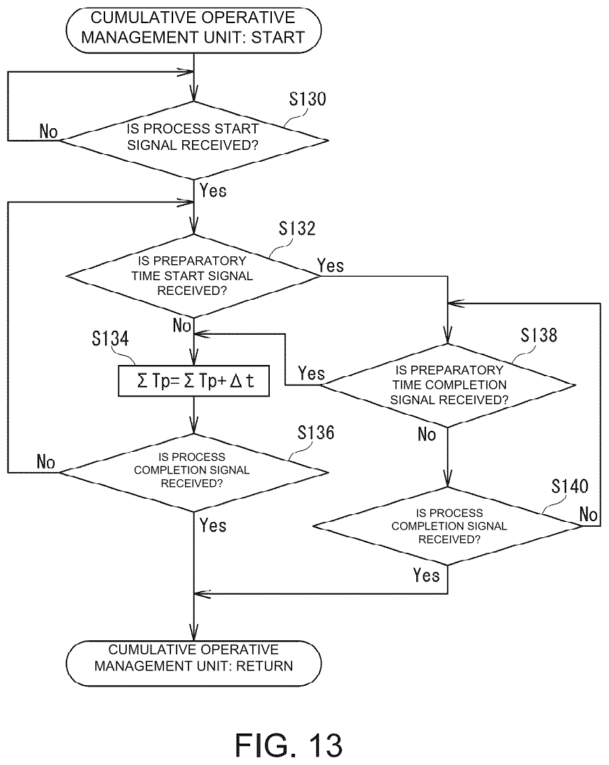

Next, a control flow of the cumulative operative management unit 24 will be described with reference to FIG. 13. When the cumulative operative management unit 24 receives the process start signal PS from the process control unit 12 (Yes in S130), the cumulative operative management unit 24 measures the cumulative operative process time ΣTp (S132 to S140). However, when the cumulative operative management unit 24 receives the preparatory time start signal CS during the measurement, the cumulative operative management unit 24 temporarily stops the measurement of the cumulative operative process time ΣTp.

More specifically, the cumulative operative management unit 24 checks whether or not the preparatory time start signal CS is received after the process start signal PS is received (S132). When the preparatory time start signal CS is not received, the cumulative operative management unit 24 calculates a value obtained by adding the control period Δt, which is predefined, to the current cumulative operative process time ΣTp, as a new cumulative operative process time ΣTp (S134). Then, the cumulative operative management unit 24 continues the measurement of the cumulative operative process time ΣTp until the process completion signal PF is received (Yes in S136), or when the preparatory time start signal CS is received (Yes in S132).

On the other hand, when the preparatory time start signal CS is received (Yes in S132), the cumulative operative management unit 24 stops the measurement of the cumulative operative process time ΣTp until the preparatory time completion signal CF is received. When the preparatory time completion signal CF is received (Yes in S138), the cumulative operative management unit 24 proceeds to step S134, and restarts the measurement of the cumulative operative process time ΣTp. In either case, when the process completion signal PF is received (Yes in S136 or Yes in S140), the cumulative operative management unit 24 returns to the start of the flow (that is, step S130), and stands by until the process start signal PS is received.

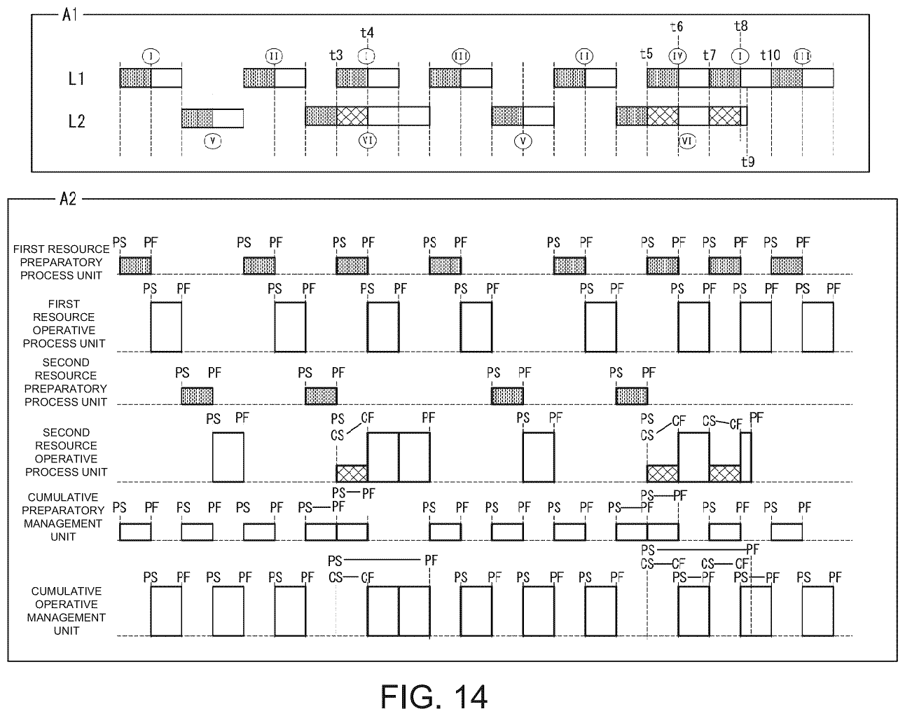

Next, an example of the cycle time calculation by the cycle time calculation apparatus 10 shown in FIG. 6 will be described. FIG. 14 is an image diagram showing calculation of the cycle time Tc shown in FIG. 2 by the cycle time calculation apparatus 10 shown in FIG. 6.

In FIG. 14, an area A1 shows progress of each process. In the area A1, a gray band shows a preparatory process. Further, in the area A1, a solid-white band shows an operative process to which the acceleration is applied, and a cross-hatched band shows an operative process to which the acceleration is not applied.

In addition, in FIG. 14, an area A2 shows measurement of the elapsed time by each of the process units 18 and 20, and the management units 22 and 24. In the area A2, the times continued in the process units 18 and 20 and the management units 22 and 24 are shown with bars. Among these times, a bar corresponding to the measured time to which the acceleration is applied has a height which is three times a height of a bar corresponding to the measured time to which the acceleration is not applied.

As shown in FIG. 14, the resource preparatory process unit 18 and the cumulative preparatory management unit 22 measure times from the reception of the process start signal PS until the reception of the process completion signal PF, without the acceleration. The resource operative process unit 20 measures the time from the reception of the process start signal PS until the reception of the process completion signal PF. If the preparatory time start signal CS is received during this period, the elapsed time is measured as the resource preparatory process time Tr; that is, a time to which the acceleration is not applied, until the reception of the preparatory time completion signal CF. The cumulative operative management unit 24 stops the measurement of the cumulative operative process time ΣTp when the cumulative operative management unit 24 receives the preparatory time start signal CS during a period after the reception of the process start signal PS until the reception of the corresponding process completion signal PF.

For example, at time t3 in FIG. 14, the process control unit 12 transmits the process start signal PS to a first resource preparatory process unit 18_1, a second resource operative process unit 20_2, the cumulative preparatory management unit 22, and the cumulative operative management unit 24. The process switching unit 14 transmits the preparatory time start signal CS to the second resource operative process unit 202 and to the cumulative operative management unit 24.

In this case, the first resource preparatory process unit 18_1 and the cumulative preparatory management unit 22 measure the elapsed times until the reception of the process completion signal PF. The second resource operative process unit 20_2 measures the elapsed time as the resource preparatory process time Tr to which the acceleration is not applied. When the second resource operative process unit 20_2 receives the preparatory time completion signal CF at time t4, the second resource operative process unit 20_2 measures the elapsed time as the resource operative process time Tp to which the acceleration is applied. In addition, the cumulative operative management unit 24 stops the measurement of the cumulative operative process time ΣTp in a period from the time t3 at which the preparatory time start signal CS is received until the time t4 at which the preparatory time completion signal CF is received.

Because the second resource operative process unit 20_2 receives the preparatory time start signal CS also at time t5 of FIG. 14, the second resource operative process unit 20_2 measures the elapsed time as the resource preparatory process time Tr to which the acceleration is not applied. Further, the cumulative operative management unit 24 stops the measurement of the operative process time ΣTp in a period from the time t5 at which the preparatory time start signal CS is received until time t6 at which the preparatory time completion signal CF is received.

With such a configuration, at time t7 at which the process IV is completed, the process VI in which the workpiece is machined by the processing machine is still in progress. As such, the process I is started after the process IV. In other words, unlike the case shown in FIG. 15, the process III to remove the workpiece from the processing machine is not started after the process IV. As a result, according to the present configuration, although the acceleration is applied to a part of the processes, the order of execution of the processes is identical to that of the actual cycle shown in FIG. 2. As a result, according to the present configuration, the cycle time Tc can be calculated accurately while shortening the time required for calculating the cycle time Tc.

With reference to the time t5 to time t10 of FIG. 14, the cumulative operative management unit 24 receives the process start signal PS at each of the times t5, t6, and t8, and then, receives the process completion signal PF respectively at each of the times t7, t9, and t10. In this case, if the control flow of FIG. 13 is applied without any change, the cumulative operative management unit 24 would complete the measurement of the cumulative operative process time ΣTp at the time t7 at which the process completion signal PF is first received. However, as is clear from FIG. 14, the measurement of the cumulative operative process time ΣTp must be continued until the time t10 at which the process completion signal PF is received for the third time. In consideration of this, the cumulative operative management unit 24 may have a counter that increments the count upon reception of the process start signal PS, and decrements the count upon reception of the process completion signal PF. The cumulative operative management unit 24 may start the measurement of the cumulative operative process time ΣTp at a timing when the count value of the counter changes from 0 to 1, and may complete the measurement of the cumulative operative process time ΣTp at a timing when the count value changes from 1 to 0. With such a configuration, the cumulative operative process time ΣTp can be measured more accurately.

The structures described above are merely exemplary, and so long as the structure described in Claim 1 is provided, the other structures may be suitably changed. For example, in the above description, the resource operative process unit 20 measures the elapsed time as an actual time (that is, the resource preparatory process time Tr) during a period in which any of the resource preparatory process unit 18 is in operation. Alternatively, the resource operative process unit 20 may temporarily stop the measurement of the elapsed time during a period in which any of the resource preparatory process units 18 is in operation.

For example, the resource operative process unit 20 may measure the elapsed time as the resource operative process time Tp at all times. The resource operative process unit 20 may temporarily stop the measurement of the elapsed time (that is, the measurement of the resource operative process time Tp) in a period after the reception of the preparatory time start signal CS until the reception of the preparatory time completion signal CF. In this case, the resource operative process unit 20 has only one timer 40, and judges that the operative process is completed when a value obtained by multiplying the resource operative process time Tp by the acceleration factor K which is predefined has reached the resource operative setting time Tp* which is predefined. With such a structure, while a slight error may occur, the cycle time Tc can be calculated with a certain degree of accuracy, with a simple structure. Further, while a configuration is described in the above description in which two work resources 110, and consequently, two resource process units 17, are provided, a larger number of the work resources 110 and the resource process units 17 may be provided.

In the case of the structure of FIG. 6, the resource operative process time Tp is calculated by adding the control period Δt for each control period, and the resource operative shaping time Tpa is calculated by adding a product of the resource operative process time Tp and the acceleration factor K, and the resource preparatory process time Tr. In this case, depending on the values of the control period Δt and the acceleration factor K, the resource operative shaping time Tpa may exceed the resource operative setting time Tp*.

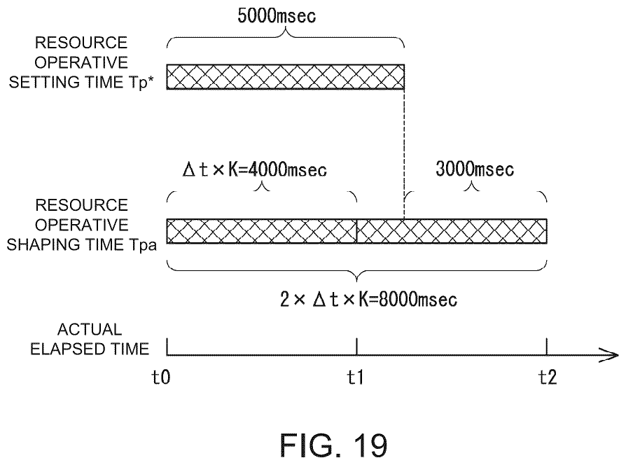

This case will now be described with reference to FIG. 19. FIG. 19 is an image diagram showing the case where the resource operative shaping time Tpa exceeds the resource operative setting time Tp*. In FIG. 19, for the purpose of explanation, it is presumed that the resource preparatory process time Tr does not occur. In FIG. 19, a case is shown in which the resource operative shaping time Tpa of an operation with the resource operative setting time Tp*=5000 msec=5 sec is counted with the control period Δt=4 msec, and the acceleration factor K=1000. In this case, the resource operative process unit 20 counts the resource operative process time Tp at a timing when the control period, Δt=4 msec, has elapsed (that is, Tp=Δt), and the resource operative shaping time Tpa in this case is Tpa=Tp×K=Δt×K=4000 msec. Because Tpa<Tp* at this point, the resource operative process unit 20 advances the timer 40 by one control period (that is, Δt=4 msec), and the resource operative process time Tp becomes Tp=Tp+Δt=2×Δt. As a result, at a timing t2, the resource operative process unit 20 counts the resource operative shaping time Tpa as Tpa=Tp×K=2×Δt×K=8000 msec. As a result, the resource operative shaping time Tpa which should be counted as 5 sec is counted as 8 sec, and an error of 3 sec occurs.

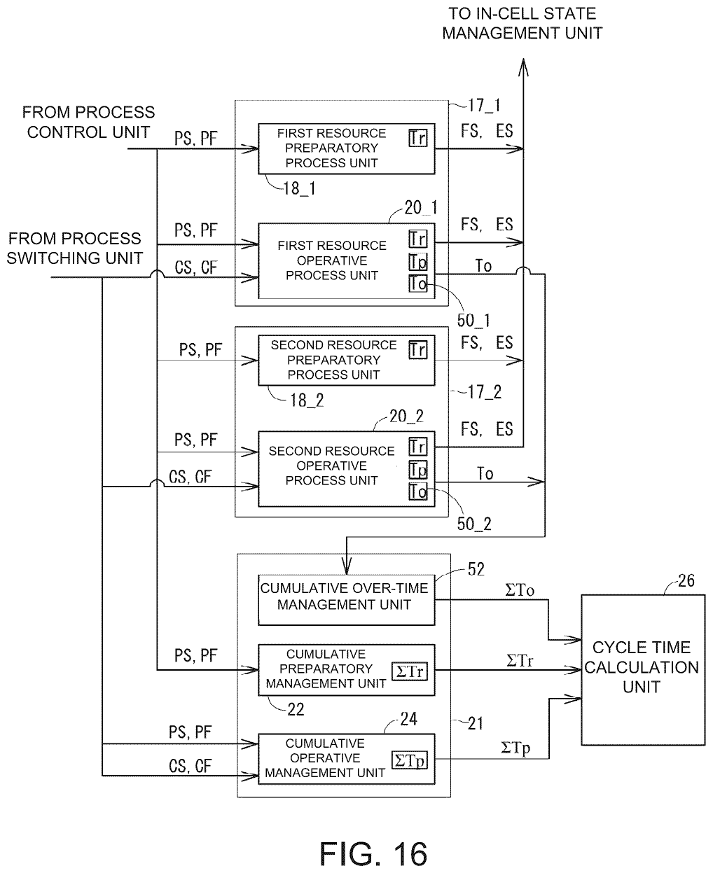

FIG. 16 is a functional block diagram showing a part of a cycle time calculation apparatus 10 for resolving such a problem. Similar to the cycle time calculation apparatus 10 shown in FIG. 6, the cycle time calculation apparatus 10 shown in FIG. 16 has the process control unit 12, the process switching unit 14, and the in-cell state management unit 16, but illustration of these units is omitted in FIG. 16.

In addition, the cycle time calculation apparatus 10 shown in FIG. 16 basically has structures and processes similar to those of the cycle time calculation apparatus 10 shown in FIG. 6, except for a structure and a process with regard to an over-time To to be described later. In the following, the structure and the process with regard to the over-time To will be primarily described, and the other structures and processes will not be repeatedly described.

In the cycle time calculation apparatus 10 shown in FIG. 16, each resource operative process unit 20 has an over-time calculation unit 50 which compares the resource operative setting time Tp* and the resource operative shaping time Tpa and calculates a difference therebetween as the over-time To. The resource operative process unit 20 outputs the calculated over-time To to a cumulative over-time management unit 52.

The cumulative over-time management unit 52 calculates a value obtained by cumulatively adding the input over-times To as a cumulative over-time ΣTo. In addition, when over-times To are input simultaneously from a plurality of resource operative process units 20, the cumulative over-time management unit 52 adds a maximum value among the plurality of over-times To to the cumulative over-time ΣTo.

The cycle time calculation unit 26 calculates, as the cycle time Tc, a value obtained by subtracting the cumulative over-time ΣTo from a value obtained by adding a product of the cumulative operative process time ΣTp and the acceleration factor K, and the cumulative preparatory process time ΣTr. That is, Tc=K×ΣTp+ΣTr−ΣTo.

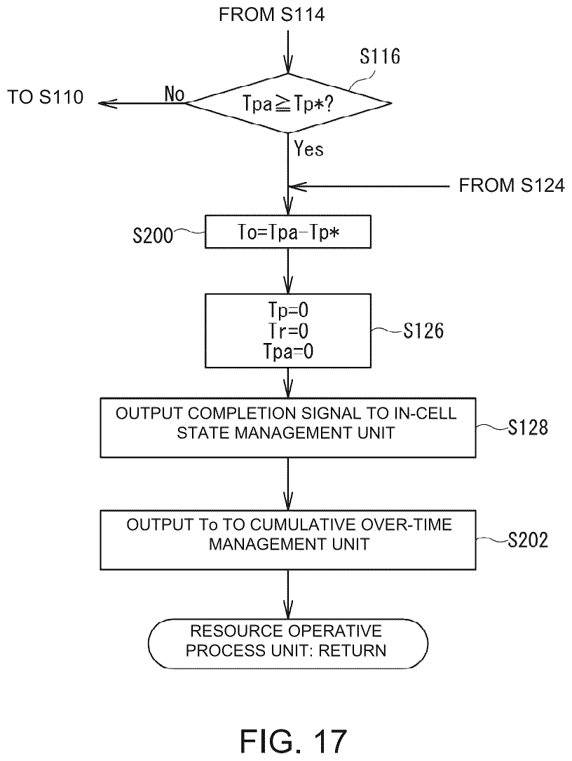

Next, the processes by the resource operative process unit 20 and the cumulative over-time management unit 52 will be described. FIG. 17 is a flowchart showing processes of a second half of the resource operative process unit 20. As processes upstream of step S200 are identical to steps S108 to S124 in FIG. 12, these steps will not be described again, and are not shown in FIG. 17.

As shown in FIG. 17, the resource operative process unit 20 completes the measurement by the timer 40 at a timing at which Tpa≥Tp* is satisfied (Yes in S116). Then, the resource operative process unit 20 calculates, as the over-time To, a value obtained by subtracting the resource operative setting time Tp* from the resource operative shaping time Tpa (S200). Naturally, when Tpa=Tp*, To=0.

The resource operative process unit 20 initializes Tp, Tr, and Tpa (S126), and outputs the completion signal FS to the in-cell state management unit 16 (S128). Further, the resource operative process unit 20 outputs the calculated over-time To to the cumulative over-time management unit 52 (S202).

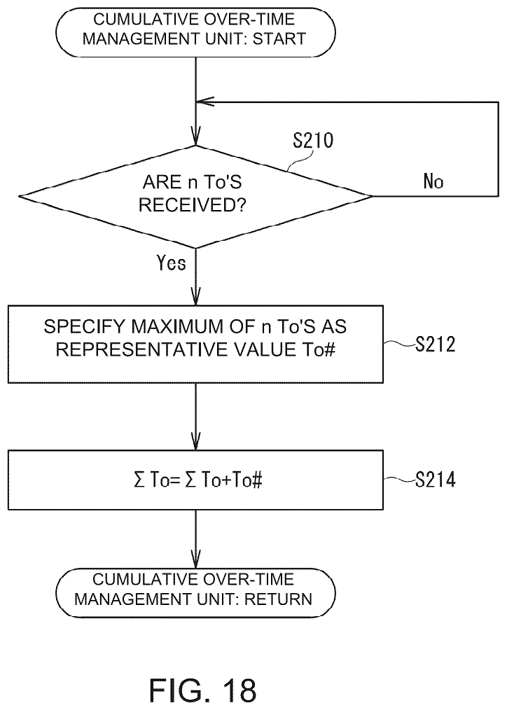

Next, a process by the cumulative over-time management unit 52 will be described with reference to FIG. 18. The cumulative over-time management unit 52 stands by for the process until the over-time To is input from the resource operative process unit 20 (S210). When the cumulative over-time management unit 52 receives n over-times To (wherein n is a natural number greater than or equal to 1) from n resource operative process units 20 (Yes in S210), the cumulative over-time management unit 52 specifies the maximum value among the plurality of over-times To as a representative value To # (S212). The cumulative over-time management unit 52 calculates a value obtained by adding the specified representative value To # to the cumulative over-time ΣTo as a new cumulative over-time ΣTo (S214). Afterwards, a similar process is repeated.

As is clear from the above description, according to the cycle time calculation apparatus 10 of FIG. 16, a part of the resource operative shaping time Tpa in excess of the resource operative setting time Tp* due to the acceleration process is calculated as the over-time To. In addition, a sum of the product of the cumulative operative process time ΣTp and the acceleration factor K, and the cumulative preparatory process time ΣTr is determined. A value obtained by subtracting the calculated cumulative over-time ΣTo from this sum is calculated as the cycle time Tc. Thus, the cycle time can be calculated more accurately. In the example configuration described above, the operative process time and the preparatory process time are measured in a separated manner. However, the process related to the over-time To can be applied to an apparatus which measures the process time without separating the process time into the operative process time and the preparatory process time, such as the cycle time calculation apparatus 10 of FIG. 3.

Alternatively, in order to remove the influence of the over-time To, in place of measuring the over-time To, a configuration may be employed to prevent the over-time To from occurring. For example, in the process flow of FIG. 12, the acceleration process is continued until the timing at which the resource operative shaping time Tpa becomes greater than or equal to the resource operative setting time Tp*; that is, until a timing tt at which the judgment in S116 results in Yes. Alternatively, the acceleration process may be completed one period prior to the timing tt. That is, the flow may transition to step S126 at the timing when Tpa becomes greater than (Tp*−Δt×K) (Tpa>(Tp*−Δt×K)), and, from this point on, the actual elapsed time may be continued to be added to the resource operative shaping time Tpa. In addition, when at least one of the resource operative process unit 20 completes the acceleration process, the other resource operative process units 20 temporarily stop the acceleration process.

When such a configuration is employed, because the acceleration process is completed one period earlier, the calculation of the cycle time requires more time, but, because the processes proceed in an order identical to the order of actual execution, the cycle time can be calculated more accurately.

### REFERENCE SIGNS LIST

10 cycle time calculation apparatus, 12 process control unit, 14 process switching unit, 16 in-cell state management unit, 17 resource process unit, 18 resource preparatory process unit, 20 resource operative process unit, 21 cumulative management unit, 22 cumulative preparatory management unit, 24 cumulative operative management unit, 26 cycle time calculation unit, 30 one or more processors, 32 memory, 34 communication I/F, 36 UI device, 40 timer, 50 over-time calculation unit, 52 cumulative over-time management unit, 100 machining cell, 106 workpiece pallet, 108 changing table, 110 work resource.

1. A cycle time calculation apparatus comprising:
one or more processors; and
a memory, wherein
the one or more processors are configured to function as:
a plurality of resource process units, each provided in correspondence to one of a plurality of work resources forming a machining cell, wherein each of the plurality of resource process units virtually judges progress of a process in a corresponding work resource based on an elapsed time from reception of a command to start a process, and outputs a result of the judgment as a resource state;
a process control unit which dynamically determines timings to start operations of the plurality of work resources based on a sequence program designated by an operator and the resource states of the plurality of resource process units, and sends a command to start a process to the resource process unit in accordance with a result of the determination;
a cumulative management unit which measures a time in which the resource state of at least one of the resource process units is in operation; and
a cycle time calculation unit which calculates a cycle time, which is a time required for actually executing machining in accordance with the sequence program, based on a result of the measurement by the cumulative management unit.

2. The cycle time calculation apparatus according to claim 1, wherein
the resource process unit calculates a process time based on the elapsed time from the reception of the command to start the process, and judges that the process in the corresponding work resource is completed when the process time has reached a resource setting time which is predefined.

3. The cycle time calculation apparatus according to claim 2, wherein
the resource process unit calculates, as the process time, a value obtained by adding a product of all or a part of the elapsed time from the reception of the command to start the process and an acceleration factor which is predefined, and a remaining time of the elapsed time from the reception of the command to start the process, and
the cycle time calculation unit calculates, as the cycle time, a value obtained by adding a product of all or a part of a measured time by the cumulative management unit and the acceleration actor, and a remaining time of the measured time.

4. The cycle time calculation apparatus according to claim 2, wherein
the resource process unit includes:
a resource preparatory process unit which virtually judges progress of a preparatory process in the corresponding work resource; and
a resource operative process unit which virtually judges progress of an operative process executed by the corresponding work resource after the preparatory process,
the resource preparatory process unit measures an elapsed time from reception of a command to start a process as a resource preparatory process time, and judges that the preparatory process is completed when the resource preparatory process time has reached a resource preparatory setting time which is predefined,
the resource operative process unit measures an elapsed time from reception of a command to start a process in a separated manner, either as a resource operative process time or the resource preparatory process time, and judges that the operative process is completed when a resource operative shaping time, which is a total of a product of the resource operative process time and an acceleration factor which is predefined, and the resource preparatory process time, has reached a resource operative setting time which is predefined,
the cumulative management unit measures, as a cumulative operative process time, a time in which at least one of the resource operative process units is measuring the resource operative process time, and measures, as a cumulative preparatory process time, a time in which at least one of the resource preparatory process units is measuring the resource preparatory process time, and
the cycle time calculation unit calculates, as the cycle time, a total of a product of the cumulative operative process time and the acceleration factor, and the cumulative preparatory process time.

5. The cycle time calculation apparatus according to claim 4, wherein
the one or more processors are further configured to function as a process switching unit, and
when the resource state of at least one of the resource preparatory process units is in-operation, the process switching unit sends a command to the resource operative process unit which is currently in operation, to measure an elapsed time from reception of a command to start a process as the resource preparatory process time, and sends a command to the cumulative management unit, to temporarily stop the measurement of the cumulative operative process time.

6. The cycle time calculation apparatus according to claim 2, wherein
the resource process unit includes:
a resource preparatory process unit which virtually judges progress of a preparatory process in the corresponding work resource; and
a resource operative process unit which virtually judges progress of an operative process executed by the corresponding work resource after the preparatory process,
the resource preparatory process unit measures an elapsed time from reception of a command to start a process as a resource preparatory process time, and judges that the preparatory process is completed when the resource preparatory process time has reached a resource preparatory setting time which is predefined,
the resource operative process unit measures an elapsed time from reception of a command to start a process as a resource operative process time, and judges that the operative process is completed when a product of the resource operative process time and an acceleration factor which is predefined has reached a resource operative setting time which is predefined,
the cumulative management unit includes:
a cumulative preparatory management unit which measures, as a cumulative preparatory process time, a time in which at least one of the resource preparatory process units is measuring the resource preparatory process time; and
a cumulative operative management unit which measures, as a cumulative operative process time, a time in which at least one of the resource operative process units is measuring the resource operative process time,
the cycle time calculation unit calculates, as the cycle time, a total of a product of the cumulative operative process time and the acceleration factor, and the cumulative preparatory process time, and
the resource operative process unit temporarily stops the measurements of the resource operative process time and the cumulative operative process time during a period in which at least one of the resource preparatory process units is measuring the resource preparatory process time.

7. A cycle time calculation apparatus comprising:
one or more processors; and
a memory, wherein
the one or more processors are configured to function as:
a plurality of resource process units, each provided in correspondence to one of a plurality of work resources forming a machining cell, wherein each of the plurality of resource process units virtually judges progress of a process in a corresponding work resource based on an elapsed time from reception of a command to start a process, and outputs a result of the judgment as a resource state;
a process control unit which dynamically determines timings to start operations of the plurality of work resources based on a sequence program designated by an operator and the resource states of the plurality of resource process units, and sends a command to start a process to the resource process unit in accordance with a result of the determination;
a cumulative management unit which measures a time in which the resource state of at least one of the resource process units is in-operation; and
a cycle time calculation unit which calculates a cycle time, which is a time required for actually executing machining in accordance with the sequence program, based on a result of the measurement by the cumulative management unit,
the resource process unit calculates, as a process time, a value obtained by adding a product of all or a part of the elapsed time from the reception of the command to start the process and an acceleration factor which is predefined, and a remaining time of the elapsed time from the reception of the command to start the process, and further calculates, as an over-time, a value obtained by subtracting a resource operative setting time, which is predefined, from the process time, and
the cycle time calculation unit calculates, as the cycle time, a value obtained by subtracting a cumulative value of the over-time from a cumulative value of the process time.

8. A cycle time calculation apparatus comprising:
one or more processors; and
a memory, wherein
the one or more processors are configured to function as:
a plurality of resource process units, each provided in correspondence to one of a plurality of work resources forming a machining cell, wherein each of the plurality of resource process units virtually judges progress of a process in a corresponding work resource based on an elapsed time from reception of a command to start a process, and outputs a result of the judgment as a resource state;
a process control unit which dynamically determines timings to start operations of the plurality of work resources based on a sequence program designated by an operator and the resource states of the plurality of resource process units, and sends a command to start a process to the resource process unit in accordance with a result of the determination;
a cumulative management unit which measures a time in which the resource state of at least one of the resource process units is in-operation; and
a cycle time calculation unit which calculates a cycle time, which is a time required for actually executing machining in accordance with the sequence program, based on a result of the measurement by the cumulative management unit,
the resource process unit calculates, as a process time, a value obtained by adding a product of all or a part of the elapsed time from the reception of the command to start the process and an acceleration factor which is predefined, and a remaining time of the elapsed time from the reception of the command to start the process, and
the resource process unit completes the process to multiply all or a part of the elapsed time by the acceleration factor at a timing when a difference between a resource operative setting time which is predefined and the process time becomes less than a product of the acceleration factor and a control period, and then adds an actual elapsed time to the process time until the process time has reached the resource operative setting time.
